(19) United States
(12) Patent Application Publication
(10) Pub. No.: US 2013/0020027 A1
(43) Pub. Date: Jan. 24, 2013

(54) ETCHING EQUIPMENT

(71) Applicant: Takuma KAMIJO, Toyota-shi (JP)

(72) Inventor: Takuma KAMIJO, Toyota-shi (JP)

(73) Assignee: TOYOTA JIDOSHA KABUSHIKI KAISHA, Toyota-shi (JP)

(21) Appl. No.: 13/275,985

(22) Filed: Oct. 18, 2011

Related U.S. Application Data
(63) Continuation of application No. PCT/JP2010/062267, filed on Jul. 21, 2011.

(51) Int. Cl. H05H 1/24

(52) U.S. Cl. 156/345.43

(57) ABSTRACT

An etching equipment including a stage, a plasma generator, a center electrode, and a peripheral electrode is provided. The work-piece is mounted on the mounting surface of the stage. The plasma generator generates plasma above the stage, wherein the plasma generator generates plasma at a higher concentration around a center axis of the mounting surface than on the center axis. The center electrode is disposed at a lower side of a space in which the plasma generator generates plasma and at a position through which the center axis passes. The center electrode is configured capable of controlling a potential of the center electrode. The peripheral electrode is disposed at an upper side of the stage and a lower side of the center electrode, wherein the peripheral electrode extends along a periphery of the center electrode. The peripheral electrode is configured capable of controlling a potential of the peripheral electrode.

### CROSS-REFERENCE TO RELATED APPLICATION

This application is a continuation of PCT application serial no. PCT/JP2010/062267 filed on Jul. 21, 2010, which PCT application designates the United States of America, and contents of which are hereby incorporated by reference.

### FIELD

A technology disclosed in the present specification relates to an etching equipment for etching a work-piece using plasma.

### DESCRIPTION OF RELATED ART

Japanese Patent Application Laid-Open No. 2004-241792 (hereinafter referred to as a patent document 1) discloses an etching equipment for etching a work-piece using plasma. This etching equipment has a stage, a chamber, a gas feed pipe and an air-core coil. When etching is performed by this etching equipment, a work-piece is mounted on the stage. Etching gas is supplied to the chamber via the gas feed pipe. Then high frequency voltage is applied to the air-core coil, and high frequency voltage is applied to the stage. When the high frequency voltage is applied to the stage, a vibrating electric field is generated in a space above the stage in the chamber. Further, when the high frequency voltage is applied to the air-core coil, a vibrating magnetic field is generated in the space above the stage in the chamber. Then due to the interaction of the electric field and the magnetic field, the etching gas is ionized, and plasma is generated in the space above the stage. When plasma is generated, the stage is negatively charged. Hence if the generated plasma moves to a space near the work-piece on the stage, ions in the plasma are accelerated toward the work-piece on the stage. Thereby the ions in the plasma are implanted into the work-piece. Furthermore, radicals in the plasma react with the work-piece. Accordingly, the work-piece is etched by the radicals and ions.

According to the etching equipment of the patent document 1, a high concentration of plasma is generated in a peripheral area of the space above the stage than in the center area of the space above the stage. If the plasma maintaining this concentration distribution reaches the work-piece, a peripheral portion of the work-piece is etched at a high rate because of the high concentration plasma, and a center portion of the work-piece is etched at a low rate because of the low concentration plasma. In other words, the etching rate on the work-piece becomes uneven. To solve this problem, the etching equipment of the patent document 1 has a focus ring disposed around the stage. High frequency voltage is applied to the focus ring. When the high frequency voltage is applied to the focus ring, ions in the plasma existing near the peripheral portion of the work-piece are attracted to the focus ring, and a reaction between the focus ring and the radicals in the plasma is promoted. According to the etching equipment of the patent document 1, plasma existing near the peripheral portion of the work-piece is attracted to the focus ring, therefore the concentration of the plasma near the peripheral portion of the work-piece drops. As a consequence, the concentration of the plasma near the work-piece becomes uniform, and the work-piece can be uniformly etched.

### BRIEF SUMMARY

The etching equipment of the patent document 1 attracts the plasma in the peripheral area to the focus ring, whereby the concentration of the plasma in the peripheral area is decreased. The plasma attracted to the focus ring does not contribute to etching the work-piece at all. Thus according to the etching equipment of the patent document 1, most of the plasma generated in the peripheral area does not contribute to etching. Therefore a problem of this etching equipment is that considerable energy is wasted, and etching is not efficient.

Accordingly, the present specification provides an etching equipment which can etch a work-piece uniformly and efficiently.

An etching equipment disclosed by the present specification etches a work-piece using plasma. This etching equipment comprises a stage, a plasma generator, a center electrode, and a peripheral electrode. The stage includes a mounting surface. The work-piece is mounted onto the mounting surface. The plasma generator generates plasma above the stage so that the plasma is generated at a higher concentration in a space around a center axis of the mounting surface than in a space on the center axis. The center electrode is disposed at a lower side of a space in which the plasma generator generates plasma and at a position through which the center axis passes. A potential of the center electrode is configured capable of being controlled. The peripheral electrode is disposed at an upper side of the stage and at a lower side of the center electrode. The peripheral electrode extends along a periphery of the center electrode when seen along the center axis. A potential of the peripheral electrode is configured capable of being controlled.

The statement “generate plasma above the stage, wherein the plasma generator generates plasma at a higher concentration in a space around a center axis of the mounting surface than on the center axis” includes a configuration which generates low concentration plasma in a space on the center axis of the mounting surface, and a configuration which does not generate plasma at all in the space on the center axis of the mounting surface.

According to this etching equipment, an electric field in a space between the center electrode and the stage (hereafter called the space above the stage) can be controlled by controlling a potential of the center electrode and a potential of the peripheral electrode during etching. The electric field extending from the center electrode toward the stage can be controlled by controlling the potential of the center electrode between a potential of a space where the plasma generator generates plasma and a potential of the stage. The electric field extending from the peripheral area toward the center area can be generated in the space above the stage by controlling the potential of the peripheral electrode between the potential of the space where the plasma generator generates plasma and the potential of the stage. As a consequence, the electric field extending toward the stage and to the center axis of the mounting surface can be generated in the space above the stage by controlling the potential of the center electrode and the potential of the peripheral electrode. By this electric field, ions in the plasma generated at a high concentration in the space of the peripheral area above the stage can be moved toward the center side of the mounting surface. As a result, the concentration of ions in the plasma becomes uniform while the plasma is reaching the work-piece on the stage. Hence ions can be implanted into the work-piece more uniformly. Therefore according to this etching equipment, the work-piece can be etched more uniformly. In this etching equipment, most of the ions in the generated plasma are implanted into the work-piece. In other words, most of the ions in the generated plasma contribute to etching. As a consequence, according to this etching equipment, the work-piece can be etched efficiently.

### BRIEF DESCRIPTION OF DRAWINGS

FIG. 1 is a vertical cross-sectional view of an etching equipment 10 of a first embodiment.

FIG. 2 is a plan view depicting an arrangement of members inside a chamber 20 when seen along a center axis 32a.

FIG. 3 is a vertical cross-sectional view for showing equipotential lines 100 in a space 44.

FIG. 4 is a graph depicting a distribution of a processing amount when etching is performed by the etching equipment 10 of the first embodiment.

FIG. 5 is a graph depicting a distribution of a processing amount when etching is performed by a conventional etching equipment.

FIG. 6 is a vertical cross-sectional view depicting an etching equipment of a variant.

FIG. 7 is a vertical cross-sectional view depicting an etching equipment of a variant.

FIG. 8 is a vertical cross-sectional view depicting an etching equipment 210 of a second embodiment.

### DETAILED DESCRIPTION OF THE PREFERRED EMBODIMENT

According to the above mentioned etching equipment provided by the present specification, the peripheral electrode may preferably extend vertically.

In this configuration, the electric field extending toward the center axis of the mounting surface can be more easily generated.

The above mentioned etching equipment may preferably further include a potential controller configured to control the potential of the center electrode and the potential of the peripheral electrode so as to be lower than a potential of the space in which the plasma generator generates plasma and higher than a potential of the stage. The potential controller may be wiring for connecting the center electrode and the peripheral electrode to a ground, or may be a power supply for applying a predetermined voltage to the center electrode and the peripheral electrode. It is preferable that the potential controller can change the potential of the center electrode separately from the potential of the peripheral electrode.

If the potential of the center electrode can be changed separately from the potential of the peripheral electrode like this, an electric field more appropriate for making the concentration of ions uniform can be generated in the space above the stage.

In the above mentioned etching equipment, the center electrode and the peripheral electrode may be configured by one electrode which is obtained by connecting the center electrode and the peripheral electrode with each other. In this case, a plurality of penetrating holes may preferably be formed on the one electrode so as to penetrate the one electrode from an upper surface to a lower surface.

According to this configuration, the plasma generated by the plasma generator can move to the space above the stage via the penetrating holes on the electrode. The plasma which moved to the space above the stage is uniformly distributed by the electric field generated by the electrode. As a consequence, the work-piece can be etched uniformly and efficiently.

### First Embodiment

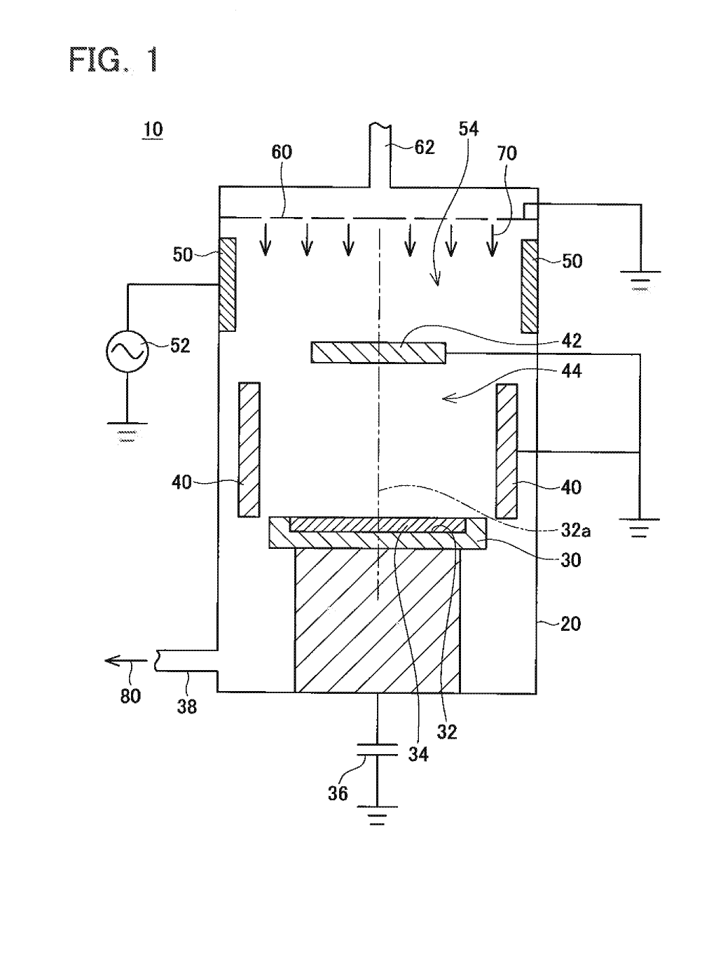

An etching equipment according to a first embodiment will be described. As FIG. 1 shows, the etching equipment 10 comprises a chamber 20. An etching gas supply pipe 62 is connected to an upper portion of the chamber 20. The etching gas supply pipe 62 supplies etching gas (SF₆ in this embodiment) into the chamber 20. An exhaust pipe 38 is connected to a lower portion of the chamber 20. The exhaust pipe 38 is connected to an exhaust pump, which is not illustrated. The exhaust pipe 38 exhausts the gas inside the chamber 20, as indicated by an arrow mark 80 in FIG. 1. A shower plate 60, an RF electrode 50, a center electrode 42, a peripheral electrode 40 and a stage 30 are disposed in the chamber 20.

The shower plate 60 is disposed at the top portion of the chamber 20. Many penetrating holes are formed on the shower plate 60. The etching gas supplied from the etching gas supply pipe 62 is introduced into the chamber 20 through the penetrating holes of the shower plate 60, as indicated by an arrow mark 70 in FIG. 1. The shower plate 60 is a conductor, and is connected to a ground.

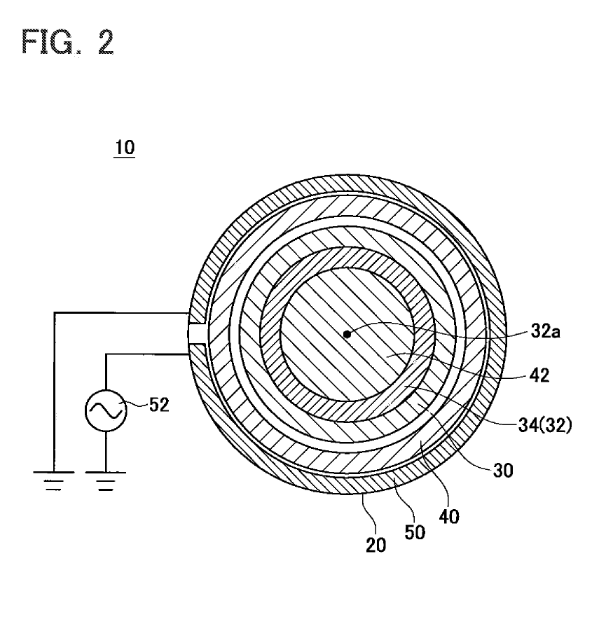

The RF electrode 50 is disposed under the shower plate 60. FIG. 2 shows an arrangement of members in the chamber 20 when seen along the center axis of the chamber 20. In FIG. 2, each member is hatched to see the drawing easily. As FIG. 2 shows, the RF electrode 50 extends circumferentially along an inner wall surface of the chamber 20. The RF electrode 50 is discontinuous at a position on the left side in FIG. 2. One end of the RF electrode 50 is connected to a high frequency power supply 52. The other end of the RF electrode 50 is connected to a ground. If high frequency voltage is applied to the RF electrode 50 by the high frequency power supply 52, a magnetic field, which vibrates vertically, is generated in a space 54 surrounded by the RF electrode 50 in FIG. 1. If the vibrating magnetic field is generated in the space 54, plasma is generated in the space 54, as mentioned later. Hereafter the space 54 is called a plasma generation space 54.

As FIG. 1 shows, the center electrode 42 is disposed under the plasma generation space 54. The center electrode 42 is disposed at a position through which a center axis 32a of a mounting surface 32 of the later mentioned stage 30 passes. As FIG. 2 shows, the center electrode 42 has a disk shape of which center coincides with the center axis 32a. A diameter of the center electrode 42 is smaller than an inner diameter of the RF electrode 50. The center electrode 42 is connected to a ground.

As FIG. 1 shows, the peripheral electrode 40 is disposed under the center electrode 42. FIG. 1 and FIG. 2 show the peripheral electrode 40 has a cylindrical shape extending vertically in the chamber 20. A center axis of the peripheral electrode 40 is approximately the same as the center axis 32a. An inner diameter of the peripheral electrode 40 is larger than a diameter of the center electrode 42. In other words, as FIG. 2 shows, the peripheral electrode 40 extends along the periphery of the center electrode 42 in a state of maintaining a distance from the center electrode 42 when seen along the center axis 32a. The peripheral electrode 40 is connected to a ground.

The stage 30 is disposed at a bottom of the chamber 20. The mounting surface 32 is formed on an upper surface of the stage 30. The mounting surface 32 is a plane of which outer shape is a circle. A wafer 34, which is a work-piece, can be mounted on the mounting surface 32. The center axis 32a of the mounting surface 32 is approximately the same as the center axis of the inner wall surface of the chamber 20. A diameter of the stage 30 is smaller than the inner diameter of the peripheral electrode 40. In other words, the diameter of the mounting surface 32 is smaller than the inner diameter of the peripheral electrode 40. The stage 30 is a conductor. The stage 30 is connected to a ground via a blocking capacitor 36.

Now an operation of the etching equipment 10 upon etching the wafer 34 will be described. A silicon layer is exposed on a surface of the wafer 34, and here an operation for etching this silicon layer will be described.

First the wafer 34 is mounted on the mounting surface 32 of the stage 30. Then an exhaust pump, which is not illustrated, is activated to exhaust gas in the chamber 20 through the exhaust pipe 38. Due to this, the atmospheric pressure in the chamber 20 is decreased. When the atmospheric pressure in the chamber 20 is sufficiently decreased, etching gas is supplied through the etching gas supply pipe 62 while continuously operating the exhaust pump. The etching gas flows into the chamber 20 via the penetrating holes of the shower plate 60. Then high frequency voltage is applied to the RF electrode 50 by the high frequency power supply 52. If the high frequency voltage is applied to the RF electrode 50, a vibrating magnetic field is generated in the plasma generation space 54. By the generating vibrating magnetic field, the etching gas in the plasma generation space 54 is ionized. Thereby plasma is generated in the plasma generation space 54. In concrete terms, the etching gas SF₆ is decomposed, and the radicals (F*, SF₅*, SF₄*), ions (SF₅⁺, SF₄²⁺) and electrons are generated. The generated electrons are attracted to the shower plate 60 and the stage 30 instantaneously. Therefore plasma constituted by the radicals and ions is generated in the plasma generation space 54. By the high frequency power supply 52 continually applying the high frequency voltage to the RF electrode 50, the plasma continues to be generated in the plasma generation space 54.

In the plasma generation space 54, a higher magnetic field is generated in a peripheral area, which is close to the RF electrode 50, than in a center area (i.e., area around the center axis 32a) which is distant from the RF electrode 50. Therefore, plasma having a higher concentration is generated in the peripheral area of the plasma generation space 54 than in the center area of the plasma generation space 54.

Further, with the plasma being generated, the electrons are attracted to the stage 30, and the stage 30 is negatively charged. In the plasma generation space 54, electrons become much less than the radicals and ions, hence the potential of the plasma generation space 54 becomes a high potential.

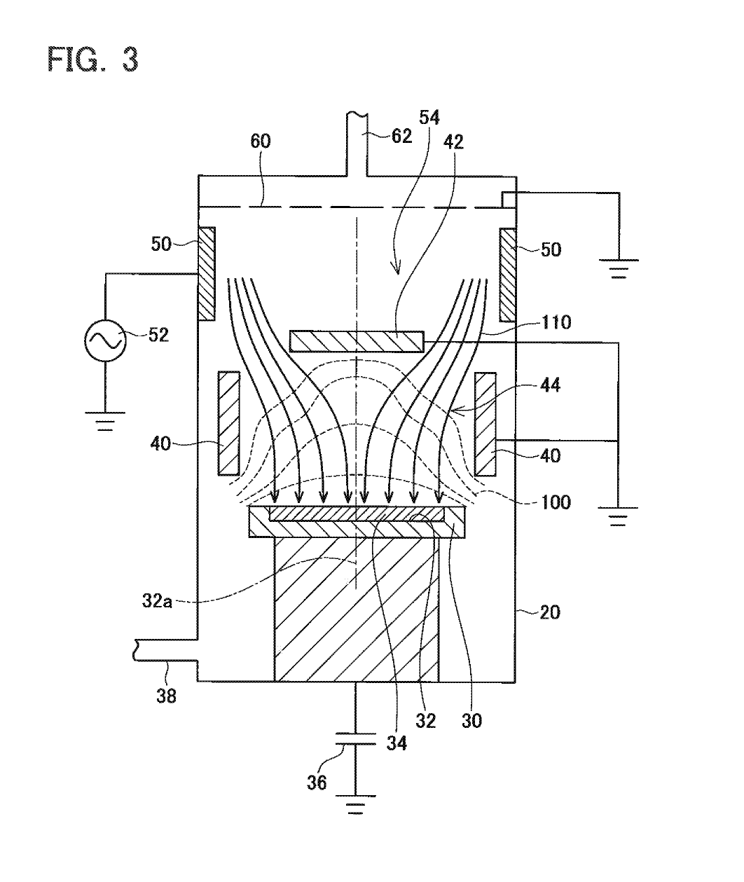

The plasma generated in the plasma generation space 54 flows downward in the chamber 20 by the flow of the gas in the chamber 20 and the repulsion between ions. In other words, the plasma flows from the plasma generation space 54 to a space 44 above the stage 30 via the space between the center electrode 42 and the peripheral electrode 40. As mentioned above, the stage 30 is negatively charged. That is, the stage 30 having negative potential exists in a lower part of the space 44. On the other hand, since the center electrode 42 and the peripheral electrode 40 are connected to the ground, the potential of the center electrode 42 and the potential of the peripheral electrode 40 are 0V. In other words, the top and sides of the space 44 are enclosed by the center electrode 42 and the peripheral electrode 40 of which potential is 0V. Therefore in the space 44, the potential is distributed as shown by the equipotential lines 100 in FIG. 3. That is, the potential is distributed so that the equipotential lines 100 protrude upward in a position close to the center axis 32a. This means that an electric field is generated from the peripheral electrode 40 side to the center axis 32a side in the space 44. The ions move in directions approximately perpendicular to the equipotential lines 100. As a consequence, the ions move toward the center axis 32a side while moving downward, as indicated by the arrow marks 110 in FIG. 3. As mentioned above, within the plasma generation space 54, plasma (that is ions) is generated at a higher concentration in the peripheral area. Since the ions generated at a high concentration in the peripheral area flow downward in the chamber 20 while being attracted to the center axis 32a, the concentration of the ions becomes more uniform in areas closer to the wafer 34.

When the plasma reaches the surface of the wafer 34, the radicals in the plasma react with the wafer 34 (that is, silicon). As a result, SiF₄ is generated on the surface of the wafer 34. The ions in the plasma which reached the surface of the wafer 34 form an ion sheath near the surface of the wafer 34. At the same time, the stage 30 is negatively charged, as mentioned above. Therefore an extremely strong electric field, extending toward the wafer 34 side, is generated near the surface of the wafer 34. By this electric field, the ions in the plasma are accelerated toward the wafer 34, and are implanted into the wafer 34. When the ions collide with the wafer 34, SiF₄, which is generated on the surface of the wafer 34, is repelled and becomes gas. When SiF₄ is repelled, the silicon is exposed, the exposed silicon and the radicals react with each other and SiF₄ is generated, and the generated SiF₄ is repelled again by the ions. As described above, the wafer 34 is etched by the iteration of the reaction of the radicals and the collision of the ions.

As mentioned above, the concentration distribution of ions is more uniform near the surface of the wafer 34. Therefore a number of ions which collide with the surface of the wafer 34 becomes more uniform within the surface. The reaction of the radicals with the wafer 34 is promoted by the collision of the ions with the wafer 34. Therefore the reaction of the radicals with the wafer 34 also becomes uniform within the surface of the wafer 34. As a consequence, according to the etching equipment 10, the surface of the wafer 34 can be uniformly etched.

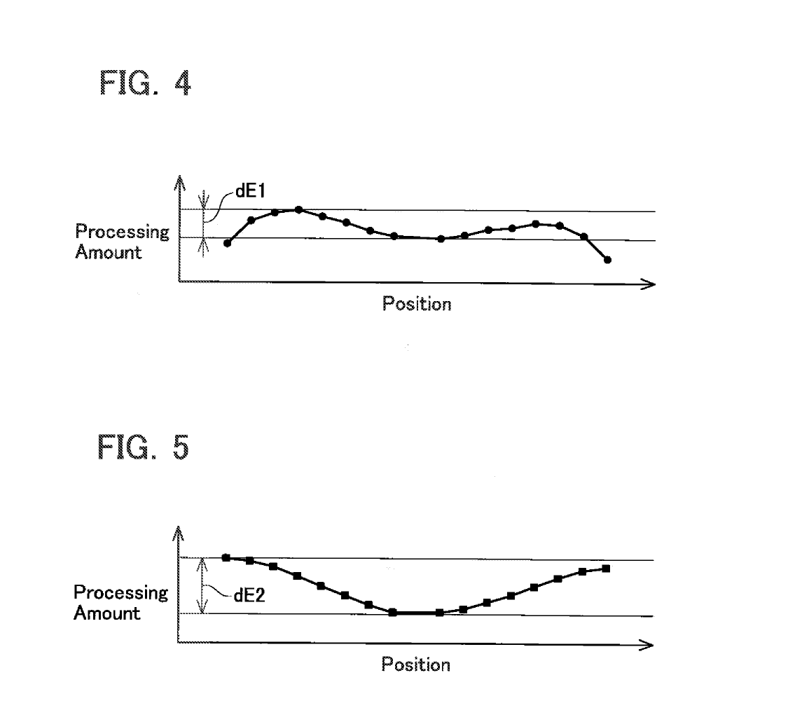

FIG. 4 shows a processing amount when the wafer is etched by the etching equipment 10 for a predetermined time. FIG. 5 shows a processing amount when the wafer is etched by an etching equipment not having the center electrode 42 and the peripheral electrode 40 for a same length of time as the case of the etching in FIG. 4. In FIG. 4 and FIG. 5, an SiO₂ film is etched in order to accurately know the concentration distribution of the ions. Since the SiO₂ film does not react with the radicals very much, the processing amount shown in FIG. 4 and FIG. 5 is predominantly the processing amount due to the collision of ions. The abscissa of FIG. 4 and FIG. 5 indicates a position in the diameter direction of the wafer. In FIG. 4, an average processing amount of an entire wafer is approximately 67 μm, while a difference dE1 of the processing amount between the center portion of the wafer and the peripheral portion of the wafer is approximately 2.5 μm. A ratio of the difference dE1 to the average processing amount is approximately 3.7%. However in FIG. 5, an average processing amount on the entire wafer is approximately 54 μm, whereas a difference dE2 of the processing amount between the center portion of the wafer and the peripheral portion of the wafer is approximately 4.5 μm. A ratio of the difference dE2 to the average processing amount is approximately 8.3%. Thus according to the etching equipment 10, more uniform etching than the conventional etching equipment can be performed.

As described above, according to the etching equipment 10, the electric field extending toward the center of the mounting surface 32 can be generated in the space 44 above the stage 30 using the center electrode 42 and the peripheral electrode 40. Therefore the etching equipment 10 can uniformly etch the wafer 34. The electric field extending toward the center of the mounting surface 32 can also be generated only by the peripheral electrode 40, without disposing the center electrode 42. However in this case, the potential distribution in the space 44 above the stage 30 fluctuates responding to the unstable potential in the plasma generation space 54. Therefore it is difficult to uniformly etch the wafer 30 without disposing the center electrode 42. According to the etching equipment 10 of this embodiment where the center electrode 42 exists, the potential distribution of the space 44 above the stage 30 can be controlled with receiving virtually no influence of the potential in the plasma generation space 54. As a consequence, the etching equipment 10 can uniformly etch the wafer 30.

Furthermore, in the etching equipment 10, the concentration distribution of the ions is made uniform near the surface of the wafer 34 by moving the ions at a high concentration generated in the peripheral area of the plasma generation space 54 to the center axis side 32a of the wafer 34. Therefore most of the generated ions contribute to the etching of the wafer 34. As a result, the etching equipment 10 can perform etching efficiently.

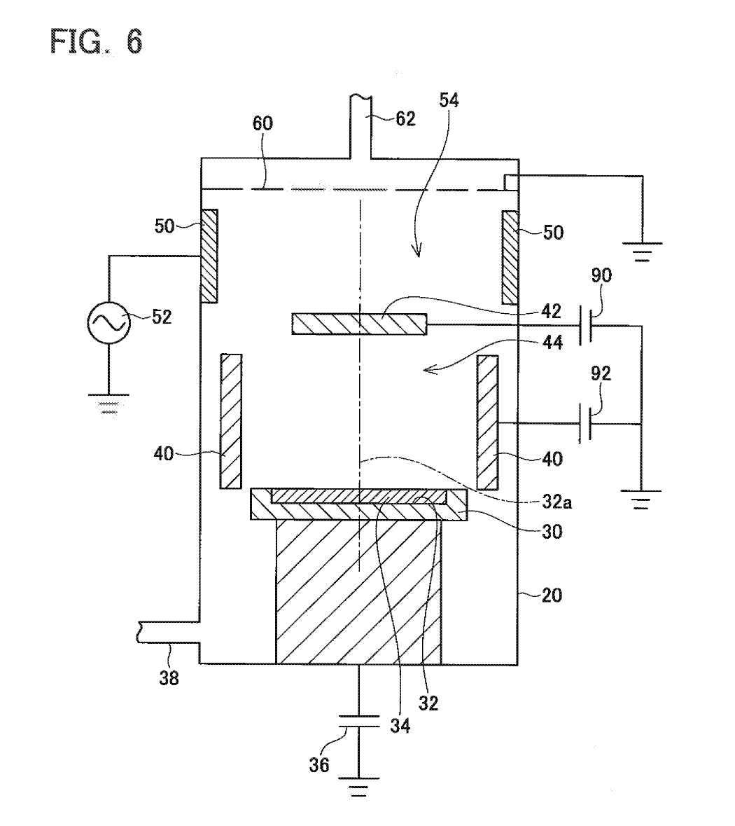

In the etching equipment 10, the center electrode 42 and the peripheral electrode 40 are connected to the ground. However as FIG. 6 shows, the center electrode 42 and the peripheral electrode 40 may be controlled to be predetermined potentials by DC power supplies 90 and 92. In this case, the concentration distribution of the ions on the surface of the wafer can be made to be uniform by controlling the potentials of the center electrode 42 and the peripheral electrode 40 to be lower than the potential of the plasma generation space 54 and higher than the potential of the stage 30. In this case, it is preferable that the applied voltage of the DC power supply 90 and the applied voltage of the DC power supply 92 be changeable. In this case, the applied voltage of the DC power supply 90 may interlock with the applied voltage of the DC power supply 92, but it is preferable that the applied voltage of the DC power supply 90 can be controlled separately from the applied voltage of the DC power supply 92. If such a configuration is used, the potential distribution in the space 44 above the stage 30 can be more finely controlled.

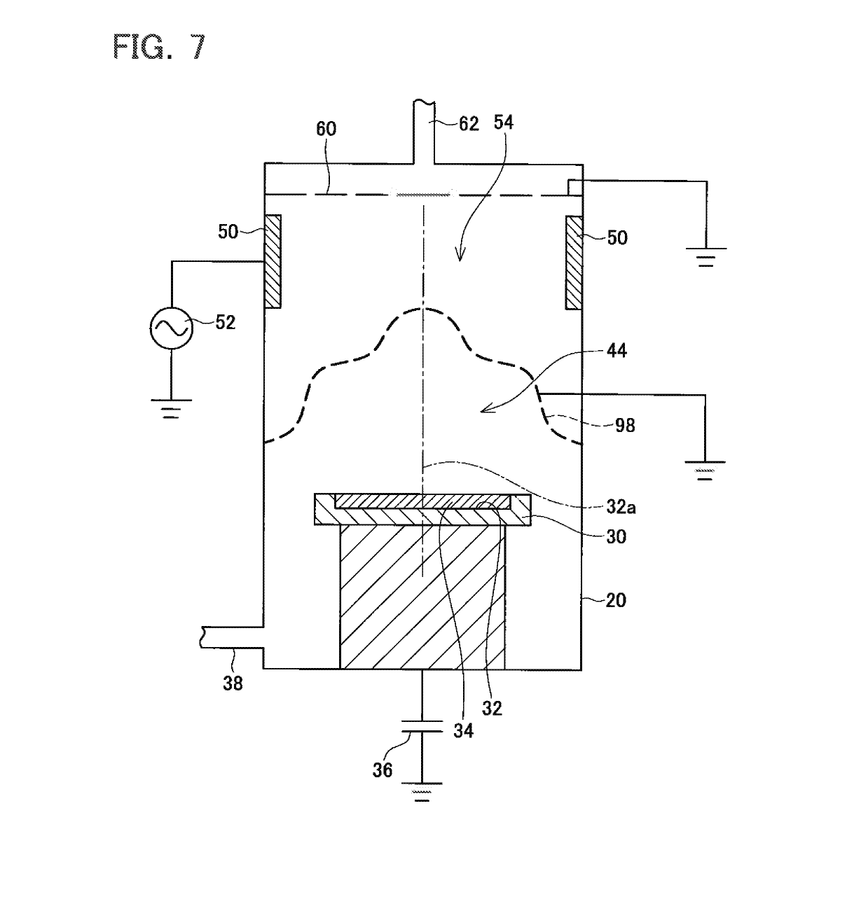

As FIG. 7 shows, a single electrode 98 may be disposed between the plasma generation space 54 and the stage 30. Many penetrating holes are formed on the electrode 98, so as to penetrate the electrode 98 from the upper surface to the lower surface. The plasma generated in the plasma generation space 54 flows to the wafer 34 side via the penetrating holes on the electrode 98. The electrode 98 has a center portion 98a which is disposed on the center axis 32a, and a peripheral portion 98b which is disposed at a lower side of the center portion 98a and extends along the periphery of the center portion 98a. The center portion 98a functions in the same manner as the above mentioned center electrode 42. The peripheral portion 98b functions in the same manner as the above mentioned peripheral electrode 40. Therefore the potential distribution in the space 44 can also be controlled by the electrode 98, just like FIG. 3. The electrode 98 can be formed to have a more complicated shape, since the center portion 98a and the peripheral portion 98b are continuous. Hence the potential distribution in the space 44 can be controlled more appropriately.

### Second Embodiment

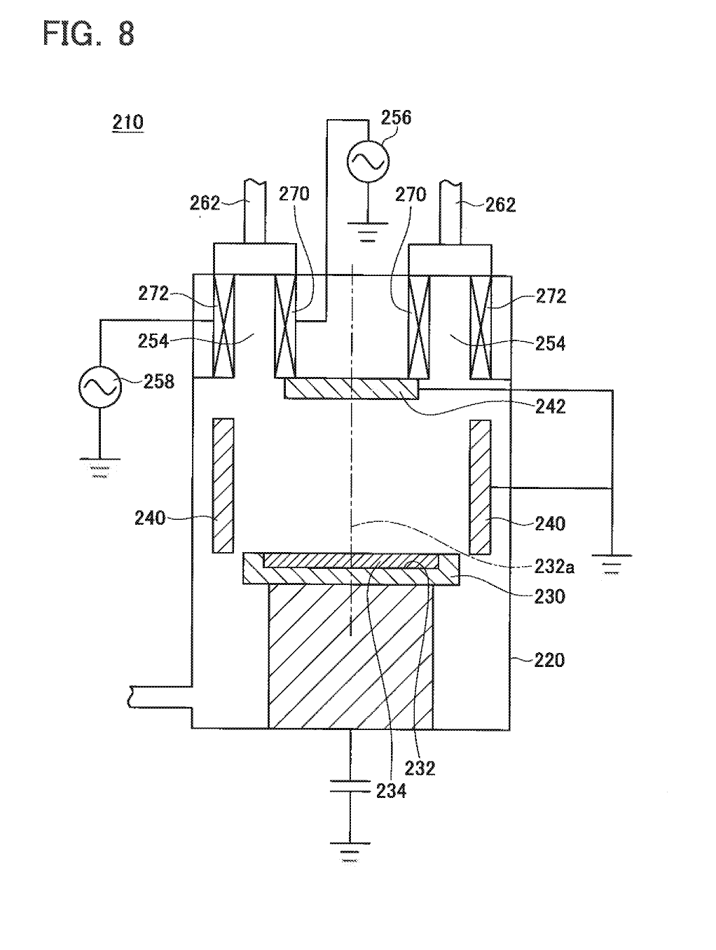

An etching equipment 210 according to a second embodiment shown in FIG. 8 will be described next. In the etching equipment 210 of the second embodiment, a chamber 220, a stage 230, a peripheral electrode 240 and a center electrode 242 are configured in a same manner as the etching equipment 10 of the first embodiment. In the etching equipment 210, a coil 270 and a coil 272 are disposed at an upper portion of the chamber 220. The coil 270 is disposed at the inner side of the coil 272. The coils 270 and 272 are disposed concentrically around a center axis 232a of the mounting surface 232 of the stage 230. Both ends of the winding of the coil 270 are connected to a high frequency power supply 256. Both ends of the winding of the coil 272 are connected to a high frequency power supply 258. The coil 270 and the coil 272 are disposed separately at a distance, and a plasma generation space 254 is formed between the coil 270 and the coil 272. An etching gas supply pipe 262 is connected to an upper surface of the chamber 220 at a position connected to the plasma generation space 254.

In operating the etching equipment 210, the pressure inside the chamber 220 is reduced first, and then etching gas is supplied from the etching gas supply pipe 262 to the plasma generation space 254. Then high frequency voltage is applied to the coils 270 and 272. Thereby a vibrating magnetic field is generated in the plasma generation space 254, and plasma is generated in the plasma generation space 254. The plasma is not generated in an area at an inner side of the winding of the coil 270 (that is, an area through which the center axis 232a of the mounting surface 232 passes). The plasma generated in the plasma generation space 254 etches the wafer 234 in the same manner as the etching equipment 10 of the first embodiment. In this case, the concentration distribution of ions near the surface of the wafer 234 is made uniform by an electric field generated by the center electrode 242 and the peripheral electrode 240. Therefore according to the etching equipment 210, the wafer 234 can be etched uniformly.

The technical elements described in the present specification and in the drawings exhibit technical utility individually or by various combinations thereof, and are not limited to the combinations stated in the claims in the application. The technology described in the present specification or in the drawings is for achieving a plurality of purposes simultaneously, and has technical utility by achieving one of these purposes.

1. An etching equipment for etching a work-piece using plasma, the etching equipment comprising:
a stage including a mounting surface onto which the work-piece is mounted;
a plasma generator configured to generate plasma above the stage, wherein the plasma generator generates plasma at a higher concentration in a space around a center axis of the mounting surface than in a space on the center axis;
a center electrode disposed at a lower side of a space in which the plasma generator generates plasma and at a position through which the center axis passes, wherein a potential of the center electrode is configured capable of being controlled; and
a peripheral electrode disposed at a upper side of the stage and a lower side of the center electrode, wherein the peripheral electrode extends along a periphery of the center electrode when seen along the center axis, and a potential of the peripheral electrode is configured capable of being controlled.

2. The etching equipment of claim 1, wherein the peripheral electrode extends vertically.

3. The etching equipment of claim 1, further comprising a potential controller configured to control the potential of the center electrode and the potential of the peripheral electrode so as to be lower than a potential of the space in which the plasma generator generates plasma and higher than a potential of the stage.

4. The etching equipment of claim 3, wherein the potential controller is configured capable of controlling the potential of the center electrode separately from the potential of the peripheral electrode.

5. The etching equipment of claim 1, wherein
the center electrode and the peripheral electrode are configured by one electrode which is obtained by connecting the center electrode and the peripheral electrode, and
a plurality of penetrating holes are formed on the one electrode so as to penetrate the one electrode from an upper surface to a lower surface.
